(19) United States
(12) Patent Application Publication
(10) Pub. No.: US 2026/0162890 A1
(43) Pub. Date: Jun. 11, 2026

(54) CAPACITOR DEVICE

(71) Applicant: DENSO CORPORATION, Kariya-city (JP)

(72) Inventors: Yuya ASAI, Kariya-city (JP); Seiichiro NISHIMACHI, Kariya-city (JP)

(73) Assignee: DENSO CORPORATION, Kariya-city (JP)

(21) Appl. No.: 19/179,132

(22) Filed: Apr. 15, 2025

Related U.S. Application Data
(63) Continuation of application No. PCT/JP2023/039676, filed on Nov. 2, 2023.

(30) Foreign Application Priority Data
Nov. 18, 2022 (JP) 2022-184819

(51) Int. Cl. H01G 2/08; H01G 2/10

(52) U.S. Cl. CPC H01G 2/08; H01G 2/103

(57) ABSTRACT

A capacitor device includes a capacitor, a capacitor busbar, and a heat dissipation busbar. The capacitor busbar has a first end and a second end. The first end is electrically connected to the capacitor, and the second end is electrically connected to an electrical component. The capacitor busbar extends in an extending direction in which the capacitor and the electrical component are aligned. The heat dissipation busbar dissipates heat generated by the capacitor. The heat dissipation busbar has an end portion at the capacitor busbar without the end portion interrupting the capacitor busbar in the extending direction of the capacitor busbar.

### CROSS REFERENCE TO RELATED APPLICATIONS

The present application is a continuation application of International Patent Application No. PCT/JP2023/039676 filed on Nov. 2, 2023, which designated the U.S. and claims the benefit of priority from Japanese Patent Application No. 2022-184819 filed on Nov. 18, 2022. The entire disclosures of all of the above applications are incorporated herein by reference.

### TECHNICAL FIELD

The present disclosure relates to a capacitor device.

### BACKGROUND

A busbar may have an electrode terminal portion, a connection terminal portion, and a relay terminal portion. The electrode terminal portion may cover end surface electrodes of a capacitor element from above.

### SUMMARY

The present disclosure describes a capacitor device that includes a capacitor, a capacitor busbar and a heat dissipation busbar.

### BRIEF DESCRIPTION OF DRAWINGS

FIG. 1 is a schematic diagram illustrating an electrical connection configuration of a power converter on which a capacitor device mounts.

FIG. 2 is a schematic diagram illustrating the power converter on which the capacitor device mounts.

FIG. 3 is a plan view of the capacitor device according to the first embodiment.

FIG. 4 is a plan view of the capacitor device of the first embodiment excluding the sealing member.

FIG. 5 is a cross-sectional view of the capacitor device taken along line V-V.

FIG. 6 is a cross-sectional view of the capacitor device taken along line VI-VI.

FIG. 7 is a cross-sectional view of the capacitor device taken along line VII-VII.

FIG. 8 is a cross-sectional view of the capacitor device illustrating the upper cover.

FIG. 9 is a cross-sectional view of a capacitor device according to a second embodiment.

FIG. 10 is a cross-sectional view of a capacitor device according to a third embodiment.

FIG. 11 is a cross-sectional view of a capacitor device according to a fourth embodiment.

FIG. 12 is a cross-sectional view of a capacitor device according to a fifth embodiment.

FIG. 13 is a cross-sectional view of a capacitor device according to a sixth embodiment.

FIG. 14 is a plan view of a capacitor device according to a seventh embodiment.

FIG. 15 is a schematic diagram illustrating a connection configuration of a capacitor device according to an eighth embodiment.

### DETAILED DESCRIPTION

A busbar may include an electrode terminal portion, a connection terminal portion, and a relay terminal portion. The electrode terminal portion may include a front plate portion, a rear plate portion, and a protruding portion that protrudes upward in a rectangular wave shape between the front plate portion and rear plate portion. Connection pins on the front and rear plates may be in contact with the end surface electrodes. The electrode terminal portion and the connection terminal portion may be connected via the relay terminal portion. The connection terminal portion may be connected to an external terminal that is connected to a power supply device.

According to the configuration described above, heat from the capacitor element is dissipated through the protruding portion. However, since the protruding portion is provided between the front plate portion and the rear plate portion in the direction in which the electrode terminal portion extends, the length of the current path of the electrode terminal portion becomes longer. Accordingly, the inductance of the electrode terminal increases. In the configuration described above, it may be difficult to improve the heat dissipation performance of the capacitor element while suppressing an increase in inductance of the electrode terminal portion.

A capacitor device according to an aspect of the present disclosure includes a capacitor, a capacitor busbar, and a heat dissipation busbar. The capacitor busbar has a first end electrically connected to the capacitor and a second end electrically connected to an electrical component. The capacitor busbar extends in an extending direction in which the capacitor and the electrical component are aligned. The heat dissipation busbar dissipates heat of the capacitor. The heat dissipation busbar has an end portion at the capacitor busbar without the end portion interrupting the capacitor busbar in the extending direction of the capacitor busbar.

Since the end of the heat dissipation busbar is arranged so as not to interrupt the capacitor busbar in the direction in which the capacitor busbar extend, the length of the current path of the capacitor busbar is prevented from increasing due to the heat dissipation busbar. Thus, it is possible to provide a capacitor device that suppresses an increase in inductance of the capacitor busbar while improving the heat dissipation performance of the capacitor.

The following will describe embodiments for carrying out the present disclosure with reference to the drawings. In each embodiment, parts corresponding to the elements described in the preceding embodiments are denoted by the same reference numerals, and redundant explanation may be omitted. When only a part of a configuration is described in an embodiment, another preceding embodiment may be applied to the other parts of the configuration.

It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

### <In-Vehicle System>

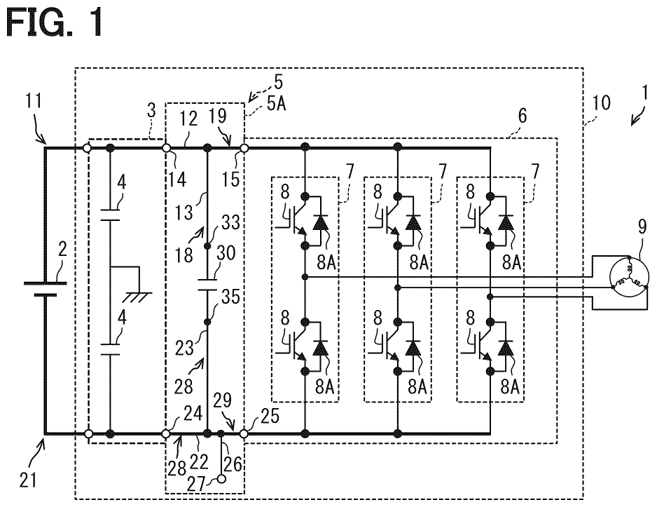

FIG. 1 is a schematic diagram illustrating an electrical connection configuration of a power converter 10 on which a capacitor device 5 having a capacitor 30 is mounted. The power converter 10 is mounted on an in-vehicle system 1. The power converter 10 includes an input-side connection portion 3, the capacitor device 5, and an inverter 6. First, the inverter 6 will be described. The inverter 6 includes multiple semiconductor modules 7. The inverter 6 performs power conversion of the power input from a high-voltage battery 2. The converted electric power is supplied to a motor generator 9.

The inverter 6 converts the DC power supplied from the high-voltage battery 2 into AC power by turning on and off a semiconductor element 8 included in the semiconductor module 7. The high-voltage battery 2 is, for example, multiple secondary batteries. The secondary batteries may be a lithium-ion secondary battery, a nickel hydrogen secondary battery, or an organic radical battery, for example.

The motor generator 9 includes a three-phase AC rotary electric machine, i.e., a three-phase AC motor. The motor generator 9 functions as a vehicle driving power source, i.e., an electric motor. The motor generator 9 functions as a generator during regeneration. The inverter 6 performs power conversion between the high-voltage battery 2 and the motor generator 9.

A capacitor device 5 is connected to the input side of the inverter 6. The input-side connection portion 3 is connected to the input side of the capacitor device 5. It is not necessary for the input-side connection portion 3 to be connected to the input side of the capacitor device 5. The capacitor device 5 may be connected to the high-voltage battery 2 without passing through the input-side connection portion 3. The capacitor device 5 includes a capacitor 30. The capacitor 30 mainly smoothens the DC voltage supplied from the high-voltage battery 2. The capacitor 30 is connected between a high-potential side power line 11 connected to the high-potential side electrode of the high-voltage battery 2 and a low-potential side power line 21 connected to the low-potential side electrode of the high-voltage battery 2.

The input-side connection portion 3 is provided with, for example, two Y-capacitors. The two Y-capacitors 4 are connected in series between the high-potential side power line 11 and the low-potential side power line 21, with the midpoint connected to ground. According to this, the Y-capacitor 4 prevents noise from flowing from the capacitor component 5A side to the high-voltage battery 2.

The motor generator 9 is connected to the output side of the inverter 6. The above-described semiconductor module 7 includes, as an example, two IGBTs and two diodes 8A. The IGBTs are semiconductor elements 8. The diode 8A is connected in anti-parallel to the semiconductor element 8. The two semiconductor elements 8 are connected in series between the high-potential side power line 11 and the low-potential side power line 21.

A collector terminal connected to the low-potential side power line 21 is connected to one of the collectors of the two semiconductor elements 8 that is provided on the high-potential side. An emitter terminal connected to the low-potential side power line 21 is connected to one of the emitters of the two semiconductor elements 8 that is provided on the low-potential side. A motor terminal connected to a motor generator 9 is connected to the emitter of the semiconductor element 8 on the high-potential side and the collector of the semiconductor element 8 on the low-potential side.

<mechanical Configuration of Capacitor Device>

Next, the mechanical configuration of the capacitor device 5 will be described. The capacitor device 5 includes a capacitor component 5A, a heat dissipation member 60, a fixing member 70, and a case 80. The capacitor component 5A includes a portion of the high-potential side power line 11, a portion of the low-potential side power line 21, a capacitor 30, a capacitor case 40, and a sealing member 50.

The capacitor case 40 is a box-shaped case that has a storage space 45 for storing the capacitor 30, a portion of the high-potential side power line 11, and a portion of the low-potential side power line 21. The capacitor case 40 is made of a resin material, for example. The storage space 45 of the capacitor case 40 is filled with the sealing member 50. The sealing member 50 is, for example, an epoxy resin.

The heat dissipation member 60 is a member made primarily of a material that has a higher thermal conductivity than air. The heat dissipation member 60 is, for example, a heat dissipation sheet, a gap filler, a heat dissipation grease, a heat dissipation adhesive, or the like. As an example, the heat dissipation member 60 is made of silicone to which metal oxide or the like is added. The fixing member 70 is a member for fixing the capacitor case 40 to the case 80. In the drawings, the heat dissipation member 60 is shown hatched with metal for convenience.

An example of the fixing member 70 is a bolt. The fixing member 70 is not limited to a bolt. The fixing member 70 may be made of an adhesive or the like. Alternatively, the fixing member 70 may be an upper cover 47 having an elastic property. The capacitor case 40 may be pressed against the case 80 by the upper cover 47. The heat dissipation member 60 may be provided between the upper cover 47 and a heat dissipation portion 27 which will be described later. The fixing member 70 may be a combination of various parts such as a bolt, an adhesive, and the upper cover 47.

The case 80 is a box-shaped case that stores these components. The case 80 is formed from a metal such as aluminum. The input-side connection portion 3, the capacitor component 5A, and the inverter 6 are stored inside the case 80. Inside the case 80, the input-side connection portion 3, the capacitor component 5A, and the inverter 6 are arranged in series. As an example, a cooling passage through which a coolant flows is formed in the base 81 of the case 80. The input-side connection portion 3, the capacitor component 5A, and the inverter 6 are cooled by the coolant flowing through the cooling passage. Additionally, the case 80 itself is cooled by the coolant. In addition, the cooling passage extends, for example, along the direction in which the input-side connection portion 3, the capacitor component 5A, and the inverter 6 are arranged. However, the extending direction of the cooling passage is not limited to this case. The cooling passage may extend, for example, in a U-shape.

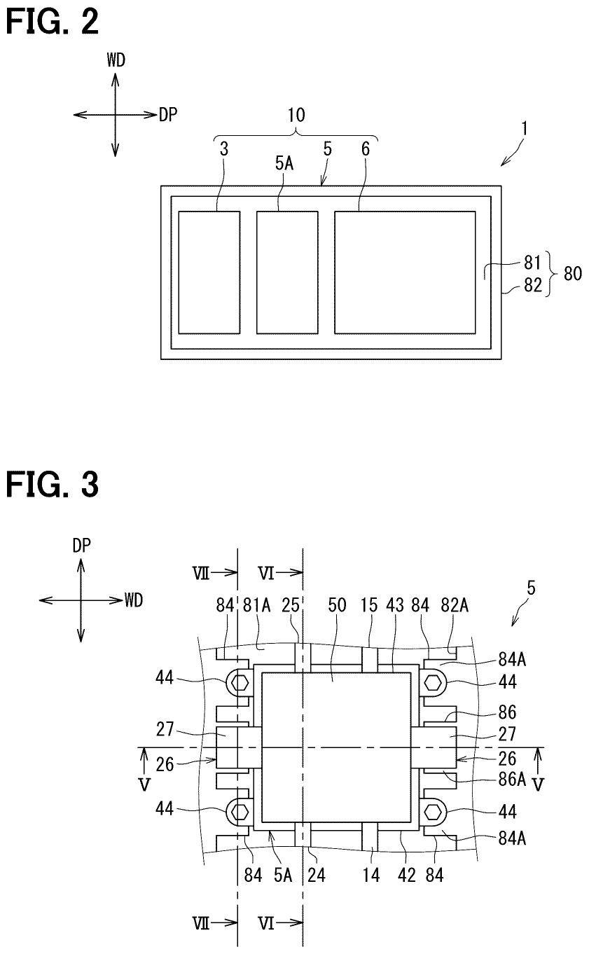

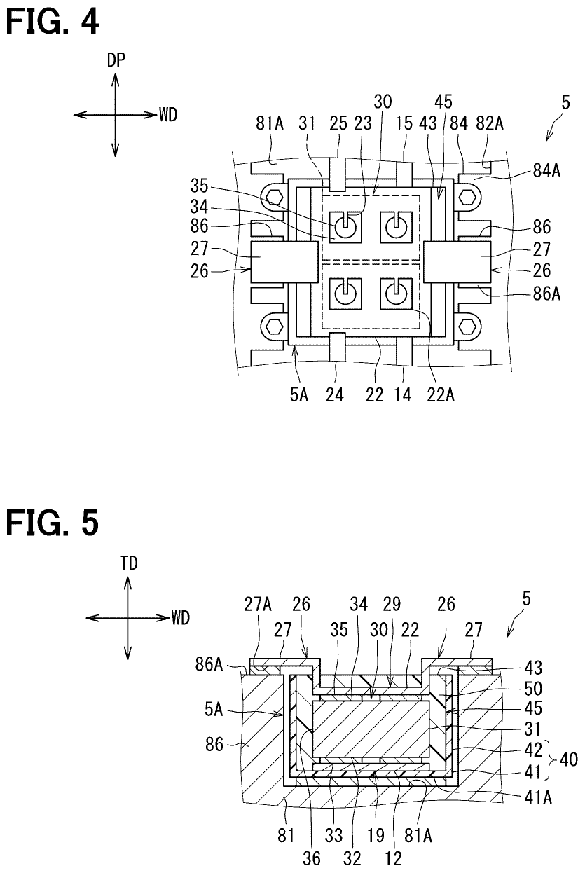

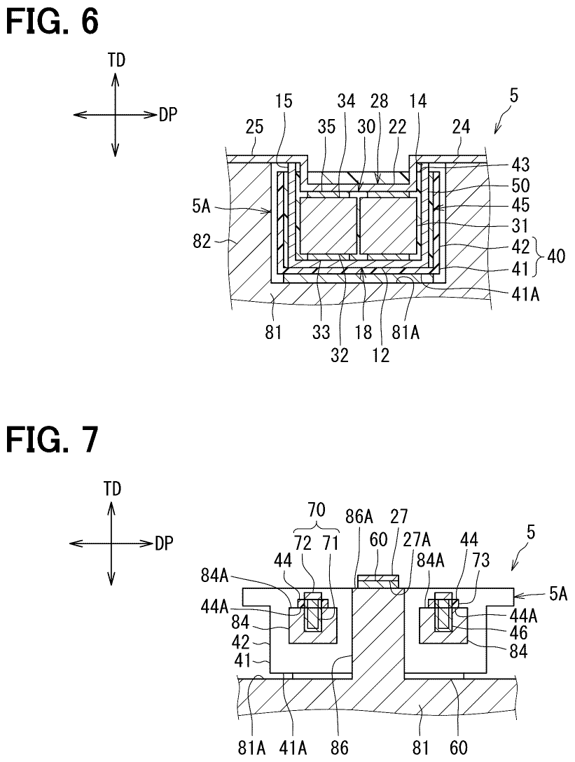

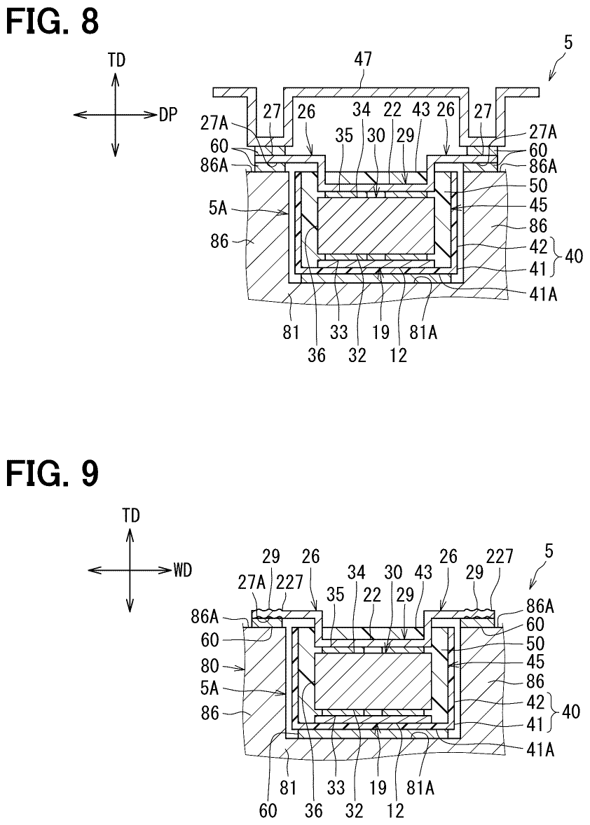

The following describes the drawings. FIG. 2 is a schematic diagram illustrating a power converter 10 on which the capacitor device 5 is mounted. FIG. 3 is a plan view of the capacitor device 5 of the first embodiment. FIG. 4 is a plan view of the capacitor device 5 of the first embodiment excluding the sealing member 50. FIG. 5 is a cross-sectional view of the capacitor device 5 taken along the line V-V in FIG. 3. FIG. 6 is a cross-sectional view of the capacitor device 5 taken along the line VI-VI in FIG. 3. FIG. 7 is a cross-sectional view of the capacitor device 5 taken along the line VII-VII in FIG. 3. FIG. 8 is a cross-sectional view of the capacitor device 5 illustrating the upper cover 47.

Regarding directions, the thickness direction of the base 81 of the case 80 may be referred to as a thickness direction TD. A depth direction perpendicular to the thickness direction TD may be referred to as a depth direction DP. A width direction perpendicular to the thickness direction TD and the depth direction DP may be referred to as a width direction WD. The depth direction DP corresponds to the direction in which the input-side connection portion 3, the capacitor component 5A, and the inverter 6 are aligned. A direction perpendicular to the thickness direction TD may be referred to as a planar direction. The planar direction is a direction along the width direction WD and the depth direction DP.

### <Capacitor>

The capacitor 30 has two capacitor elements 31, for example. The number of capacitor elements 31 is not limited to two. The number of capacitor elements 31 may be any number. The capacitor element 31 is, for example, a film capacitor element. A film capacitor is formed by providing a metal vapor deposition electrode on a dielectric film and winding the dielectric film so that the metal deposited electrodes face each other. Metallicon electrodes are formed on both end faces of the film capacitor by spraying metal. The metal deposited electrode is electrically connected to one of the metallicon electrodes. The other metallicon electrode is electrically connected to a metal deposited electrode. In the drawings, the capacitor 30 is shown hatched as if it were made of metal for the sake of convenience.

The capacitor element 31 has a three-dimensional shape with a certain volume. The capacitor element 31 may be provided in a three-dimensional shape such as a cylinder, an elliptical cylinder, a polygonal prism, a cube, or a rectangular parallelepiped. The capacitor element 31 has at least two end faces 32, 34 and a side surface 36. One end surface of capacitor element 31 in thickness direction TD is called a first end surface 32. The metallicon electrode provided on the first end surface 32 is called a first electrode 33. The other end surface of capacitor element 31 in thickness direction TD is called a second end surface 34. The metallicon electrode provided on the second end surface 34 is called a second electrode 35.

The first electrode 33 and the second electrode 35 are spaced apart from each other in the thickness direction TD. The side surface 36 connects the first end surface 32 and the second end surface 34. The side surface 36 extends along the edges of the first end surface 32 and the second end surface 34. The side surface 36 can also be said to extend circumferentially along the edges of the first end surface 32 and the second end surface 34 around an axis along the thickness direction TD.

The two capacitor elements 31 are aligned in the depth direction DP in the storage space 45 of the capacitor case 40. The two capacitor elements 31 are connected in parallel by electrical wiring (not shown). The direction in which the electrodes of the two capacitor elements 31 are aligned is equivalent to the thickness direction TD. The first end faces 32 and first electrodes 33 of two capacitor elements 31 are provided on one side in the thickness direction TD. The second end surfaces 34 and second electrodes 35 of two capacitor elements 31 are provided on the other side in the thickness direction TD.

The capacitor case 40 described above has a thin bottom 41 in the thickness direction TD and an annular wall 42 rising annularly from the bottom 41. The annular wall 42 can also be called a side wall. The bottom 41 and the annular wall 42 define a storage space 45 for storing the capacitor 30. Further, an opening 43 that opens in the thickness direction TD and communicates with the storage space 45 is defined by an end of the annular wall 42 that is apart from the bottom 41. In the first embodiment, the first end surface 32 and the first electrode 33 correspond to the bottom 41 side, and the second end surface 34 and the second electrode 35 correspond to the opening 43 side.

### <High-Potential Side Power Line>

The high-potential side power line 11 is formed by connecting four power lines, for example. The power line connecting the high-potential side of the high-voltage battery 2 and the input-side connection portion 3 may be referred to as a first power line. The power line that connecting the high-voltage battery 2 and the capacitor device 5 on the high-potential side of the input-side connection portion 3 may be referred to as a second power line. The power line connecting the input-side connection portion 3 and the inverter 6 on the high-potential side of the capacitor component 5A may be referred to as a third power line. The power line that connects the capacitor component 5A and the semiconductor module 7 on the high-potential side of the inverter 6 may be referred to as a fourth power line.

The high-potential side power line 11 is made up of the first power line, the second power line, the third power line, and the fourth power line. Hereafter, the third power line is provided by a first power busbar 12. The first power busbar 12 is a current path that connects the input-side connection portion 3 and the inverter 6. The first power busbar 12 is a current path through which current mainly flows between the input-side connection portion 3 and the inverter 6.

The first power busbar 12 has a plate shape that is thin in the thickness direction TD. The first power busbar 12 is disposed so as to face the first end faces 32 of the two capacitor elements 31. A first exposure hole for exposing the first electrodes 33 is formed in the first power busbar 12 at a location where the first power busbar 12 overlaps with the two first electrodes 33. The shape of the first exposure hole is similar to that of a second exposure hole 22A described below, so the description of the second exposure hole 22A will also include the description of the first exposure hole.

A first capacitor connection terminal 13 electrically connected to the first electrode 33 is provided on an edge that defines a portion of the first exposure hole in the first power busbar 12. The first capacitor connection terminal 13 extends from an edge that defines a portion of the first exposure hole toward the first electrode 33. The first capacitor connection terminal 13 and the first electrode 33 are connected by soldering, for example.

The first power busbar 12 also has two ends spaced apart in the depth direction DP. The first power busbar 12 has a first inverter connection terminal 15 connected to the inverter 6 at one end in the depth direction DP. The first inverter connection terminal 15 extends in thickness direction TD along a side surface 36 of the capacitor element 31 beyond the opening 43, and then extends in the depth direction DP away from the capacitor case 40. The first inverter connection terminal 15 is electrically and mechanically connected to the fourth power line via a bolt or the like (not shown).

On the other hand, the first power busbar 12 has a first input connection terminal 14 connected to the input-side connection portion 3 at the other end in the depth direction DP. The first input connection terminal 14 extends along the side surface 36 of the capacitor element 31 in the thickness direction TD until it extends over the opening 43, and then extends in the depth direction DP so as to be deviated from the capacitor case 40. The first input connection terminal 14 is electrically and mechanically connected to the second power line via a bolt or the like (not shown).

Hereinafter, the first power busbar 12 and the first capacitor connection terminal 13 may be collectively referred to as a first busbar 18. In other words, the first busbar 18 includes the first power busbar 12 and the first capacitor connection terminal 13. The input-side connection portion 3, the inverter 6, and the capacitor 30 are electrically connected via the first busbar 18.

### <First Capacitor Busbar>

The first busbar 18 also includes a first capacitor busbar 19 that connects the capacitor 30 and the inverter 6. The first capacitor busbar 19 includes a first capacitor connection terminal 13 and a portion of the first power busbar 12. The portion of the first power busbar 12 is the portion from the connection portion of the first power busbar 12 with the capacitor connection terminal 13 to the connection portion the first power busbar 12 with the inverter 6. The first busbar 18 can also be said to include the first capacitor busbar 19 and the remainder of the first power busbar 12.

The first capacitor busbar 19 extends in the direction in which the capacitors 30 and the inverter 6 are aligned. As an example, the first capacitor busbar 19 extends in the depth direction DP. The first capacitor busbar 19 has a first capacitor connection terminal 13 at one end in the depth direction DP. The first capacitor busbar 19 has a first inverter connection terminal 15 at the other end in the depth direction DP. The first capacitor busbar 19 is a current path through which current mainly flows between the capacitor 30 and the inverter 6. The first capacitor busbar 19 includes a path that connects the first capacitor connection terminal 13 and the first inverter connection terminal 15 in the shortest possible manner.

### <Low-Potential Side Power Line>

The low-potential side power line 21 is formed by connecting four power lines, for example. The power line connecting the low-potential side of the high-voltage battery 2 and the input-side connection portion 3 may be referred to as a fifth power line. The power line connecting the high-voltage battery 2 and the capacitor device 5 on the low-potential side of the input-side connection portion 3 may be referred to as a sixth power line. The power line connecting the input-side connection portion 3 and the inverter 6 on the low-potential side of the capacitor component 5A may be referred to as a seventh power line. The power line connecting the capacitor component 5A and semiconductor module 7 on the low-potential side of inverter 6 may be referred to as an eighth power line.

The low-potential side power lines 21 are made up of the fifth power line, the sixth power line, the seventh power line, and the eighth power line. And then, the seventh power line is provided from the second power busbar 22. The second power busbar 22 is a current path connecting the input-side connection portion 3 and the inverter 6. The second power busbar 22 is a current path through which current mainly flows between the input-side connection portion 3 and the inverter 6.

The second power busbar 22 has a plate shape that is thin in the thickness direction TD. The second power busbar 22 is arranged to face the second end faces 34 of the two capacitor elements 31. The second exposure holes 22A for exposing the second electrodes 35 are formed in the second power busbar 22 at locations where the second power busbar 22 overlaps with the two second electrodes 35.

A second capacitor connection terminal 23 is provided on the current path of the second power busbar 22. More specifically, the second capacitor connection terminal 23 that is electrically connected to the second electrode 35 is provided on an edge that defines a portion of the second exposure hole 22A in the second power busbar 22. The second capacitor connection terminal 23 extends from an edge that defines a portion of the second exposure hole 22A toward the second electrode 35. The second capacitor connection terminal 23 and the second electrode 35 are connected by soldering, for example.

In addition, the second power busbar 22 has two ends spaced apart in the depth direction DP. The second power busbar 22 has a second inverter connection terminal 25 connected to the inverter 6 at one end in the depth direction DP. The second inverter connection terminal 25 extends in the thickness direction TD along the side surface 36 of the capacitor element 31 until it extends over the opening 43, and then extends in the depth direction DP so as to be away from the capacitor case 40. The second inverter connection terminal 25 is electrically and mechanically connected to the eighth power line 21C via a bolt or the like (not shown).

On the other hand, the second power busbar 22 has a second input connection terminal 24 connected to the input-side connection portion 3 at the other end in the depth direction DP. The second input connection terminal 24 extends along the side surface 36 of the capacitor element 31 in the thickness direction TD until extending over the opening 43, and then extends in the depth direction DP so as to be deviated from the capacitor case 40. The second input connection terminal 24 is electrically and mechanically connected to the sixth power line via a bolt or the like (not shown).

Further, the second power busbar 22 has two ends spaced apart from each other in the width direction WD. A heat dissipation busbar 26 for dissipating heat from the capacitor 30 is provided at one end and the other end in the width direction WD of the second power busbar 22. The heat dissipation busbar 26 is integrally connected to the second power busbar 22. The heat dissipation busbar 26 is continuous with the second power busbar 22 and is made of the same material. The heat dissipation busbar 26 will be described in detail later.

Hereinafter, the second power busbar 22, the second capacitor connection terminal 23, and the heat dissipation busbar 26 may be collectively referred to as a second busbar 28. In other words, the second busbar 28 includes the second power busbar 22, the second capacitor connection terminal 23, and the heat dissipation busbar 26. The input-side connection portion 3, the inverter 6, and the capacitor 30 are electrically connected via the second busbar 28.

### <Second Capacitor Busbar>

The second busbar 28 also includes a second capacitor busbar 29 that connects the capacitor 30 and the inverter 6. The second capacitor busbar 29 includes the second capacitor connection terminal 23 and a portion of the second power busbar 22. The portion of the second power busbar 22 is the portion from the connection portion of the second power busbar 22 with the capacitor connection terminal 23 to the connection portion of the second power busbar 22 with the inverter 6. The second busbar 28 can also be said to include the second capacitor busbar 29, the heat dissipation busbar 26 and the remainder of the second power busbar 22.

The second capacitor busbar 29 extends in the direction in which the capacitors 30 and the inverter 6 are aligned. As an example, the second capacitor busbar 29 extends in the depth direction DP. The second capacitor busbar 29 has a second capacitor connection terminal 23 at one end in the depth direction DP. The second capacitor busbar 29 has a second inverter connection terminal 25 at the other end in the depth direction DP. The second capacitor busbar 29 is a current path through which current mainly flows between the capacitor 30 and the inverter 6. The second capacitor busbar 29 includes a path that connects the second capacitor connection terminal 23 and the second inverter connection terminal 25 in the shortest possible manner.

### <Heat Dissipation Busbar>

The heat dissipation busbar 26 is a portion for dissipating heat from the capacitor 30. The heat dissipation busbar 26 is made of a busbar as a conductive member. For this reason, the heat dissipation busbar 26 may be referred to as a heat dissipation busbar. The heat dissipation busbar 26 is cantilevered from the second capacitor busbar 29. The end of the heat dissipation busbar 26 away from the second capacitor busbar 29 is an open end. The shape of the heat dissipation busbar 26 is not limited to this case. The modifications of the heat dissipation busbar 26 will be described later.

The heat dissipation busbar 26 extends in the thickness direction TD away from capacitor element 31 until passing over the opening 43, and then extends in width direction WD away from capacitor case 40. The two heat dissipation busbars 26 extend away from each other in the thickness direction TD.

As described above, the second capacitor busbar 29 extends in the direction in which the capacitors 30 and the inverter 6 are aligned. The heat dissipation busbar 26 is a current path that branches off from the second capacitor busbar 29 in a branch-like manner. The heat dissipation busbar 26 extends in a direction different from the direction in which the second capacitor busbar 29 extends. The heat dissipation busbar 26 is provided on the second capacitor busbar 29 so as not to interrupt the second busbar 29 in the direction in which the second capacitor busbar 29 extends. The current flowing through the heat dissipation busbar 26 is less than the current flowing through the second capacitor busbar 29.

The heat dissipation busbar 26 may or may not have an electrical insulation function. If the heat dissipation busbar 26 does not have an electrical insulating function, insulation from the surrounding components is ensured by providing a spatial distance or by placing a member with insulating function between the busbar and the surrounding components. An example of a member having an insulating function is a gap filler.

As an example of providing a heat dissipation function to the heat dissipation busbar 26, an insulating protective film may be provided on the surface of the heat dissipation busbar 26. The protective film is provided on the surface by, for example, painting. The shape of the heat dissipation busbar 26 is not limited as long as the heat dissipation busbar 26 has an insulating function. The surface of the heat dissipation busbar 26 may be covered with an insulated covering member.

### <Sealing Resin and Busbar>

The capacitor 30 provided with the first busbar 18 and the second busbar 28 is stored in the storage space 45 of the capacitor case 40. The storage space 45 is filled with the sealing member 50. As an example, the sealing member 50 is filled up to the opening 43 in the thickness direction TD. The capacitor 30, a portion of the first busbar 18, and a portion of the second busbar 28 are sealed by the sealing member 50.

The first capacitor connection terminal 13, a portion of the first input connection terminal 14, and a portion of the first inverter connection terminal 15 are sealed in the sealing member 50. The remainder of the first input connection terminal 14 and the remainder of the first inverter connection terminal 15 are exposed from the sealing member 50. The main portion of the first power busbar 12 refers to a portion of the first power busbar 12 that faces the first end surface 32.

The main portion of the second power busbar 22, the second capacitor connection terminal 23, a portion of the second input connection terminal 24, a portion of the second inverter connection terminal 25, and portions of the two heat dissipation busbars 26 are sealed in the sealing member 50. The remainder of the second input connection terminal 24, the remainder of the second inverter connection terminal 25, and the remainder of the two heat dissipation busbars 26 are exposed from the sealing member 50. The main portion of the second power busbar 22 refers to the portion of the second power busbar 22 that faces the second end surface 34. The heat dissipation portion 27 at the tip of the heat dissipation busbar 26 is exposed from the sealing member 50. The heat dissipation portion 27 is exposed to air.

The capacitor case 40 also includes four heat dissipation walls 44 for fixing to the case 80. The four flange portions 44 are provided on the annular wall 42 of the capacitor case 40. The four flange portions 44 are provided in pairs on each wall of the annular wall 42 that are spaced apart in the width direction WD.

The number of flange portions 44 is not limited. The flange portion 44 extends in the width direction WD so as to be deviated from the annular wall 42. The flange portion 44 has a plate shape that is thin in the thickness direction TD. Further, the flange portion 44 is provided with a through hole penetrating in the thickness direction TD. The through hole is provided with a cylindrical metal member called a collar 73 for passing a shaft portion 71 of the fixing member 70 such as a bolt.

### <Case and Capacitor Case>

As described above, the case 80 is a box-shaped housing that stores the input-side connection portion 3, the capacitor component 5A, and the inverter 6 therein. The case 80 includes the base 81 having a small thickness in the axial direction, and a wall 82 standing upright from the base 81. The base 81 and the wall 82 define a storage space for storing the input-side connection portion 3, the capacitor component 5A, and the inverter 6.

A fixing wall 84 to which the flange portion 44 is fixed is provided on an inner surface 82A of two walls 82 spaced apart in the width direction WD. In the thickness direction TD, the flange portion 44 and the fixing wall 84 overlap each other. Two fixing walls 84 are provided on each of the two walls 82 spaced apart in the width direction WD, corresponding to each flange portion 44.

As an example, the fixing wall 84 is integrally formed on the inner surface 82A. The fixing wall 84 is provided on the inner surface 82A away from the base 81. The fixing wall 84 extends from the inner surface 82A along the width direction WD. A fixing surface 84A of the fixing wall 84 to which the flange lower surface 44A of the flange portion 44 is fixed extends along the planar direction perpendicular to the thickness direction TD. The flange lower surface 44A extends along the planar direction.

Furthermore, in addition to the fixing wall 84, a heat dissipation wall 86 on which the heat dissipation portion 27 is provided is provided on the inner surface 82A of the two walls 82 spaced apart in the width direction WD. As an example, the heat dissipation wall 86 is integrally connected to the upper surface 81A and the inner surface 82A of the base 81. The heat dissipation wall 86 protrudes from the base 81 in the thickness direction TD. Furthermore, the heat dissipation wall 86 extends in the width WD direction from the inner surface 82A. A heat-dissipating upper surface 86A of the heat dissipation wall 86 to which the heat-dissipating lower surface 27A of the heat dissipation portion 27 is fixed extends in the planar direction. The heat-dissipating lower surface 27A extends in a planar direction. The upper surface 81A may be referred to as the upper surface of the base.

Two fixing walls 84 and one heat dissipation wall 86 are provided on one of the two inner surfaces 82A spaced apart in the width direction WD. In the depth direction DP, a heat dissipation wall 86 is provided between the two fixing walls 84. In the depth direction DP, the two fixing walls 84 and the heat dissipation wall 86 are provided at a predetermined distance from each other. Similarly, two fixing walls 84 and one heat dissipation wall 86 are provided on another of the two inner surfaces 82A spaced apart in the width direction WD. The two fixing walls 84 and the heat dissipation wall 86 provided on the other one of the two inner surfaces 82A are the same as those described above, and therefore will not be described here.

The capacitor device 5 has a flange portion 44 and four sets of fixing walls 84 corresponding to the flange portion 44. Depending on the number of flange portions 44, the capacitor device 5 may have multiple sets of flange portions 44 and fixing walls 84 corresponding to the flange portions 44. On one of the two inner surfaces 82A spaced apart in the width direction WD, the heat dissipation portion 27 and the heat dissipation wall 86 are provided between two pairs of flange portions 44 and fixing walls 84 spaced apart in the depth direction DP. On another of the two inner surfaces 82A, the heat dissipation portion 27 and the heat dissipation wall 86 are provided between two pairs of flange portions 44 and fixing walls 84 spaced apart in the depth direction DP.

### <Heat Dissipation Material and Case>

The capacitor component 5A is provided in the case 80 such that the lower surface 41A of the bottom 41 faces the upper surface 81A of the base 81 and the two heat-dissipating lower surfaces 27A face the two heat-dissipating upper surfaces 86A. As described above, the fixing surface 84A, the flange lower surface 44A, the heat-dissipating lower surface 27A, and the heat-dissipating upper surface 86A extend along the planar direction. Therefore, the normal directions of the fixing surface 84A, the flange lower surface 44A, the heat-dissipating upper surface 27A, and the heat-dissipating upper surface 86A are the same. The normal direction is equivalent to the thickness direction TD. The lower surface 41A may be referred to as the bottom lower surface.

In addition, the heat dissipation members 60 are provided between the base 81 and the bottom 41 and between the two heat dissipation walls 86 and the two heat dissipation portions 27. The heat dissipation member 60 in close contact with the base 81 and the bottom 41 in the normal direction. The heat dissipation member 60 in close contact with the heat dissipation wall 86 and the heat dissipation portion 27 in the normal direction. More specifically, the heat dissipation member 60 in close contact with the upper surface 81A and the lower surface 41A in the normal direction. The heat dissipation member 60 in close contact with the heat dissipating upper surface 86A and the heat-dissipating lower surface 27A in the normal direction.

The capacitor component 5A is provided in the case 80 so that the distance between the contact portion, which is formed between the first capacitor connection terminal 13 and the first electrode 33, and the heat dissipation member 60, which is located between base 81 and bottom 41, is the shortest. The capacitor component 5A is provided in the case 80 so that the distance between the contact portion, which is formed between the second capacitor connection terminal 23 and the second electrode 35, and the heat dissipation member 60, which is located between the heat dissipation wall 86 and the heat dissipation portion 27, is the shortest.

The first busbar 18 is soldered to the first electrode 33. The capacitor 30 is thermally connected to the base 81 via the first busbar 18, the sealing member 50, the bottom 41, and the heat dissipation member 60. The second busbar 28 is soldered to the second electrode 35. The capacitor 30 is thermally connected to the heat dissipation wall 86 via the second capacitor busbar 29, the heat dissipation busbar 26, and the heat dissipation member 60.

### <Fixing Member and Heat Dissipation Member>

The fixing member 70 includes a shaft portion 71 and a head portion 72 provided at the tip of the shaft portion 71. The shaft portion 71 is in the thickness direction TD, that is, the normal direction described above. The part of the shaft portion 71 on the head portion 72 side is passed through the collar 73 provided on the flange portion 44. The part of the shaft portion 71 away from the head portion 72 is inserted into a fastening hole 46. During manufacture, the fixing member 70 penetrates through the holes in the collar 73 and the fastening holes 46 in the thickness direction TD toward the base 81. The shaft portion 71 is formed with a first thread shape. The fastening hole 46 is formed with a second thread shape that corresponds to the first thread shape. The first thread shape and the second thread shape are fitted together to fix the shaft portion 71 in the fastening hole 46.

The flange portion 44 is pressed against the fixing wall 84 in the thickness direction TD toward the base 81 by the fixing member 70. The heat dissipation member 60 provided between the heat dissipation portion 27 and the heat dissipation wall 86 is crushed in the thickness direction TD. As a result, the heat dissipation member 60 in close contact with the heat-dissipating lower surface 27A and the heat dissipating upper surface 86A.

Furthermore, the bottom 41 is pressed against the base 81 in the thickness direction TD. The heat dissipation member 60 provided between the bottom 41 and the base 81 is crushed in the thickness direction TD. As a result, the heat dissipation member 60 in close contact with the lower surface 41A and the upper surface 81A.

### Operational Effects

The capacitor device 5 includes the capacitor 30, the second capacitor busbar 29, and the heat dissipation busbar 26. The second capacitor busbar 29 is a current path through which current mainly flows between the capacitor 30 and the inverter 6. The second capacitor busbar 29 extends in the direction in which the capacitors 30 and the inverter 6 are aligned. The heat dissipation busbar 26 extends in a direction different from the direction in which the second capacitor busbar 29 extends. The heat dissipation busbar 26 is provided on the second capacitor busbar 29 without interrupting the second capacitor busbar 29 in the extension direction of the second capacitor busbar 29.

This prevents the current path length of second capacitor busbar 29 from becoming longer. This suppresses an increase in inductance of the second capacitor busbar 29. Furthermore, heat from the capacitor 30 is dissipated from the heat dissipation busbar 26. The heat dissipation performance of the capacitor 30 is improved. In this way, it is possible to provide the capacitor device 5 that suppresses an increase in inductance of the second capacitor busbar 29 while improving the heat dissipation performance of the capacitor 30.

Furthermore, the current flowing through the heat dissipation busbar 26 is smaller than the current flowing through the second capacitor busbar 29. Accordingly, the temperature of the heat dissipation busbar 26 is lower than the temperature of the second capacitor busbar 29. By deliberately providing the heat dissipation busbar 26 through which a smaller current flow than the second capacitor busbar 29 and actively cooling the heat dissipation busbar 26, the temperature of the second busbar 28 can be efficiently lowered. Accordingly, heat from the capacitor 30 is easily dissipated to the second busbar 28. The capacitor 30 is likely to be cooled efficiently.

Unlike the present embodiment, in another configuration in which a heat dissipation busbar 26 interrupts the second capacitor busbar 29 in the direction in which the second capacitor busbar 29 extends, there are concerns that the amount of current flowing between the multiple capacitor elements 31 connected in parallel may become uneven and that the inductance component may increase. For this reason, in the configuration in which the heat dissipation busbar 26 interrupts the second capacitor busbar 29, a design that takes these concerns into consideration is required. The structure of the capacitor device 5 is limited.

On the other hand, in the present embodiment, the heat dissipation busbar 26 is provided on the second capacitor busbar 29 without interrupting the second capacitor busbar 29 in the direction in which the second capacitor busbar 29 extends, so there is no need to take these concerns into consideration. Therefore, the degree of freedom in the structure of the capacitor device 5 is improved. As one variation of the capacitor device 5, the heat dissipation area of the heat dissipation busbar 26 can be easily changed.

Furthermore, if the heat balance of the capacitor element 31 is different, for example, only the upper surface of the element is hot, the heat dissipation area of heat dissipation portion 27 can be increased to adjust so that the element can be cooled uniformly. This effect is obtained by providing the heat dissipation busbar 26 for heat dissipation in addition to the second capacitor busbar 29. To repeat, in another embodiment in which the heat dissipation busbar 26 interrupts the second capacitor busbar 29 in the direction in which the second capacitor busbar 29 extends, it is not easy to change the size of the heat dissipation busbar 26 due to the inductance and current distribution of the capacitor element 31.

Unlike the present embodiment, in another embodiment in which the heat dissipation busbar 26 is separated from the second electrode 35 via the sealing member 50 or the like, the heat from the capacitor 30 is less likely to be transferred to the heat dissipation busbar 26 due to the presence of the sealing member 50. Heat is less likely to be transferred from the capacitor 30 to the heat dissipation busbar 26. On the other hand, in the present embodiment, since the heat dissipation busbar 26 is electrically and mechanically connected to the second electrode 35, heat is easily transferred from the capacitor 30 to the heat dissipation busbar 26. Therefore, in the present embodiment, the capacitor 30 can be cooled efficiently.

The second power busbar 22 is a power line that connects the input-side connection portion 3 and the inverter 6 on the low-potential side. The input-side connection portion 3 has the Y-capacitor 4. The heat of the Y-capacitor 4 is transferred to the heat dissipation busbar 26 via the sixth power line 21B, a portion of the second power busbar 22, and the second capacitor busbar 29. The heat from the semiconductor module 7 is transferred to the heat dissipation busbar 26 via the eighth power line and the second capacitor busbar 29. The heat from the heat dissipation busbar 26 is dissipated not only from the capacitor 30 but also from the Y-capacitor 4 and the semiconductor module 7. In this embodiment, the heat dissipation area and thickness of the heat dissipation busbar 26 can be freely adjusted so that heat from the Y-capacitor 4 and the semiconductor module 7 in addition to the capacitor 30 can be efficiently dissipated. This effect is obtained by providing the heat dissipation busbar 26 for heat dissipation on the second capacitor busbar 29.

The capacitor case 40 is a case that includes the storage space 45 for storing the capacitor 30. The storage space 45 stores the capacitor 30 provided with the first busbar 18 and the second busbar 28. The storage space 45 is filled with the sealing member 50. The capacitor 30, a portion of the first busbar 18, and a portion of the second busbar 28 are sealed by the sealing member 50. As described above, the heat dissipation busbar 26 is cantilevered from the second capacitor busbar 29 of the second power busbar 22.

A portion of the heat dissipation busbar 26 is sealed with the sealing member 50. The remainder of the heat dissipation busbar 26 is exposed from the sealing member 50. The heat dissipation portion 27 of the heat dissipation busbar 26 exposed from the sealing member 50 is exposed to air. This allows the heat dissipation portion 27 to be easily cooled. The heat of the capacitor 30 is easily dissipated from the heat dissipation portion 27 to the outside air. The capacitor 30 can be cooled efficiently.

The case 80 is a housing that stores the capacitor 30 and through which a coolant flows. The case 80 has the heat dissipation wall 86 on which the heat dissipation portion 27 is provided. The heat dissipation member 60 is provided between the heat dissipation wall 86 and the heat dissipation portion 27. The heat dissipation member 60 is a member that is mainly made of a material that has a higher thermal conductivity than air. The heat dissipation member 60 in close contact with the heat dissipation wall 86 and the heat dissipation portion 27. This allows the heat of the capacitor 30 to be easily transferred from the heat dissipation portion 27 to the heat dissipation wall 86 via the heat dissipation member 60. Since the coolant flows through the case 80, the temperature of the heat dissipation wall 86 is low. The capacitor 30 can be cooled efficiently.

The capacitor case 40 has the thin bottom 41 in the thickness direction TD and the annular wall 42 rising annularly from the bottom 41. The storage space 45 is defined by the bottom 41 and the annular wall 42. The capacitor case 40 also has four flange portions 44 for fixing to the case 80. The four flange portions 44 are provided on the annular wall 42 of the capacitor case 40. The flange portion 44 extends along the width WD direction so as to be deviated from the annular wall 42.

The case 80 also has a fixing wall 84 to which the flange portion 44 is fixed. The flange portion 44 overlaps with the fixing wall 84 in the thickness direction TD. The flange portion 44 is pressed against the fixing wall 84 toward the base 81 in the thickness direction TD and fixed thereto. Accordingly, the heat dissipation portion 27 is pressed against the heat dissipation wall 86 toward the base 81 in the thickness direction TD. As a result, the heat dissipation member 60 provided between the heat dissipation portion 27 and the heat dissipation wall 86 is crushed in the thickness direction TD. The heat dissipation member 60 in close contact with the heat dissipation portion 27 and the heat dissipation wall 86.

Further, the fixing member 70 is passed through the collar 73 provided on the flange portion 44 and the fastening hole 46 of the fixing wall 84. The fixing member 70 has a shaft portion 71 and a head portion 72. The shaft portion 71 extends in the thickness direction TD. A part of the shaft portion 71 on the head portion 72 side is passed through the collar 73. A part of the shaft portion 71 away from the head portion 72 is inserted into the fastening hole 46.

The heat-dissipating upper surface 86A of the heat dissipation wall 86 and the heat-dissipating lower surface 27A of the heat dissipation portion 27 extend in the planar direction. The normal direction of the upper heat dissipating surface 86A and the normal direction of the heat-dissipating lower surface 27A are equal to the thickness direction TD. The flange portion 44 is pressed against the fixing wall 84 in the thickness direction TD toward the base 81 by the fixing member 70.

As a result, the heat dissipation member 60 provided between the heat dissipation portion 27 and the heat dissipation wall 86 is crushed in the thickness direction TD and comes into uniform close contact with the heat-dissipating lower surface 27A and the heat-dissipating upper surface 86A. Accordingly, the contact area of the heat dissipation member 60 between the heat-dissipating lower surface 27A and the upper heat-dissipating surface 86A increases. As a result, the cooling effect is improved. Furthermore, the heat dissipation portion 27 can be easily cooled simply by fixing the flange portion 44 to the fixing wall 84 via the fixing member 70, which improves manufacturability. The same effect can be obtained even if the fixing member 70 is, for example, an adhesive material instead of a bolt.

Furthermore, since the heat dissipation portion 27 can be cooled from the case 80 side, a space can be provided above the capacitor component 5A. For this purpose, for example, a control board for controlling the semiconductor module 7 can be disposed above the capacitor component 5A. This allows for greater freedom in layout.

On one of the two inner surfaces 82A spaced apart in the width direction WD, the heat dissipation portion 27 and the heat dissipation wall 86 are provided between two sets of flange portions 44 and fixing walls 84 spaced apart in the depth direction DP. On another of the two inner surfaces 82A, the heat dissipation portion 27 and the heat dissipation wall 86 are provided between two sets of flange portions 44 and fixing walls 84 spaced apart in the depth direction DP. In the depth direction DP, the two fixing walls 84 and the heat dissipation wall 86 are provided at a predetermined distance from each other. The flange portion 44 is pressed against the two fixing walls 84 in the thickness direction TD by the fixing member 70, so that the heat dissipation member 60 provided between the heat dissipation portion 27 and the heat dissipation walls 86 is uniformly crushed. Accordingly, the contact area of the heat dissipation member 60 between the heat-dissipating lower surface 27A and the upper heat-dissipating surface 86A increases. As a result, the cooling effect is improved.

The capacitor 30 is provided in the storage space 45 so that the first electrode 33 corresponds to the bottom 41 side and the second electrode 35 corresponds to the opening 43 side. The capacitor component 5A is provided inside the case 80 so that the bottom 41 of the capacitor case 40 faces the base 81 and the heat dissipation portion 27 faces heat dissipation wall 86. The heat dissipation member 60 is provided between the base 81 and the bottom 41 and between the heat dissipation wall 86 and the heat dissipation portion 27. The heat dissipation member 60 in close contact with the base 81 and the bottom 41, as well as with the heat dissipation wall 86 and the heat dissipation portion 27 in the thickness direction TD.

Accordingly, the capacitor 30 is thermally connected to the base 81 via the first busbar 18, the sealing member 50, the bottom 41, and the heat dissipation member 60. The capacitor 30 is thermally connected to the heat dissipation wall 86 via the second busbar 28 and the heat dissipation member 60. As a result, the capacitor 30 can be cooled from both sides of the electrodes 33 and 35. Since the capacitor 30 can be cooled uniformly, the cooling effect of the capacitor 30 is improved.

Additionally, the upper surface 81A of the base 81 and the lower surface 41A of the bottom 41 extend in the planar direction. The normal direction of the upper surface 81A and the normal direction of the lower surface 41A are equivalent to the thickness direction TD. That is, the normal direction of the heat-dissipating upper surface 86A, the heat-dissipating lower surface 27A, the upper surface 81A, and the lower surface 41A is equivalent to the thickness direction TD. Therefore, the compressive force applied by the fixing member 70 to crush the heat dissipation member 60 is uniformly transmitted to the heat dissipation member 60. Accordingly, the cooling effect of the capacitor 30 is improved. In this manner, the heat dissipation member 60, which is between the heat dissipation wall 86 and the heat dissipation portion 27, and the heat dissipation member 60, which is between the base 81 and the bottom 41, are both pressed uniformly against the case 80 by the compressive force of the same fixing member 70. By simply fastening the flange portion 44 to the fixing wall 84, a double-sided cooling structure can be realized.

### Second Embodiment

A second embodiment will be described with reference to FIG. 9. FIG. 9 is a cross-sectional view of the capacitor device 5 according to the second embodiment. In the following description of the second embodiment, changes from the first embodiment will be mainly described. In the second embodiment, two heat dissipation portions 27 are provided with uneven shapes 227 that are uneven in the thickness direction TD. Accordingly, the heat-dissipating lower surface 27A is uneven in the thickness direction TD.

Therefore, the surface area of the second heat-dissipating lower surface 27A is increased compared to the first embodiment. The contact area between the heat-dissipating lower surface 27A and the heat dissipation member 60 is increased compared to the first embodiment. The capacitor 30 can be cooled efficiently. In the second embodiment, the heat dissipation member 60 is embedded in the uneven shape 227. Therefore, even if the capacitor device 5 vibrates, the uneven shape 227 and the heat dissipation member 60 are unlikely to separate from each other. This makes it easier to prevent the heat dissipation portion 27 from unintentionally coming off the heat dissipation member 60 and touching the case 80. It is possible to prevent dielectric breakdown between the heat dissipation portion 27 and the case 80.

### Third Embodiment

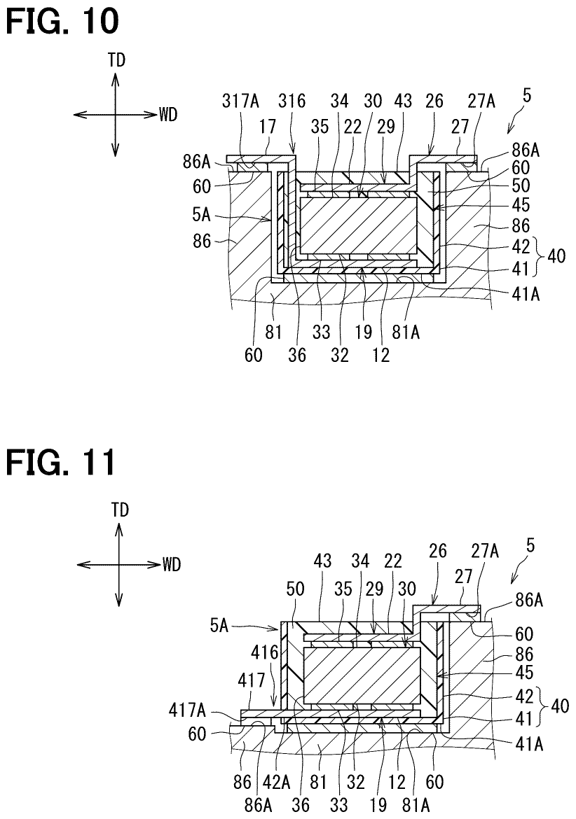

A third embodiment will be described with reference to FIG. 10. FIG. 10 is a cross-sectional view of a capacitor device 5 according to the third embodiment. In the following description of the third embodiment, changes from the first embodiment will be mainly described. In the third embodiment, the first busbar 18 has a heat dissipation busbar in addition to the first power busbar 12, the first input connection terminal 14, and the first inverter connection terminal 15. In the third embodiment, the heat dissipation busbar included in the first busbar 18 may be referred to as a first heat dissipation busbar 316. The heat dissipation busbar included in the second busbar 28 may be referred to as the second heat dissipation busbar 26. That is, in the third embodiment, the capacitor device 5 includes a first heat dissipation busbar 316 and the second heat dissipation busbar 26.

The first power busbar 12 has two ends spaced apart in the width direction WD. The first heat dissipation busbar 316 is provided at one of the two ends spaced apart in the width direction WD. The first heat dissipation busbar 316 is integrally connected to the first power busbar 12. The first heat dissipation busbar 316 is continuous with the first power busbar 12 and is made of the same material. The first busbar 18 includes the first power busbar 12, the first capacitor connection terminal 13, and the first heat dissipation busbar 316.

The first heat dissipation busbar 316 is cantilevered from the first power busbar 12. The first heat dissipation busbar 316 is cantilevered from the first capacitor busbar 19. The end of the first heat dissipation busbar 316 away from the first capacitor busbar 19 is an open end. The shape of the first heat dissipation busbar 316 is not limited to this. Modifications of the first heat dissipation busbar 316 will be described later. The first heat dissipation busbar 316 extends in the thickness direction TD away from the capacitor element 31 until it extends over the opening 43, and then extends in the width direction WD away from the capacitor case 40.

The first capacitor busbar 19 extends in the direction in which the capacitors 30 and the inverter 6 are aligned. The first heat dissipation busbar 316 is a current path that branches off from the first capacitor busbar 19 in a branch shape. The first heat dissipation busbar 316 extends in a direction different from the direction in which the first capacitor busbar 19 extends. The first heat dissipation busbar 316 is provided on the first capacitor busbar 19 without interrupting the first capacitor busbar 19 in the direction in which the first capacitor busbar 19 extends. The current flowing through the first heat dissipation busbar 316 is smaller than the current flowing through the first capacitor busbar 19.

The second heat dissipation busbar 26 differs from the first embodiment in that the second heat dissipation busbar 26 is provided at only one of two ends spaced apart in the width direction WD. Other configurations are similar to those of the first embodiment, and thus the description thereof will be omitted again.

Also in the third embodiment, the capacitor 30 provided with the first busbar 18 and the second busbar 28 is stored in the storage space 45 of the capacitor case 40. The sealing member 50 seals the main portion of the first power busbar 12, the first capacitor connection terminal 13, a portion of the first input connection terminal 14, the first inverter connection terminal 15, and a portion of the first heat dissipation busbar 316. The remainder of the first input connection terminal 14, the remainder of the first inverter connection terminal 15, and the remainder of the first heat dissipation busbar 316 are exposed from the sealing member 50. A first heat dissipation portion 317 at the tip of the first heat dissipation busbar 316 is exposed from the sealing member 50. The first heat dissipation portion 317 is exposed to air.

The sealing member 50 seals the main portion of the second power busbar 22, the second capacitor connection terminal 23, a portion of the second input connection terminal 24, a portion of the second inverter connection terminal 25, and portions of the two heat dissipation busbars 26. The remainder of the second input connection terminal 24, the remainder of the second inverter connection terminal 25, and the remainder of the second heat dissipation busbar 26 are exposed from the sealing member 50. The second heat dissipation portion 27 at the tip of the second heat dissipation busbar 26 is exposed from the sealing member 50. The second heat dissipation portion 27 is exposed to air. The first heat dissipation portion 317 and the second heat dissipation portion 27 extend in the width direction WD so as to be deviated from each other from the capacitor case 40.

In the third embodiment, one of the two heat dissipation walls 86 separated in the width direction WD faces the first heat dissipation portion 317 in the thickness direction TD. The heat dissipation member 60 is provided between the heat dissipation wall 86 and the first heat dissipation portion 317. Similarly, another of the two heat dissipation walls 86 separated in the width direction WD faces the second heat dissipation portion 27 in the thickness direction TD. The heat dissipation member 60 is provided between the heat dissipation wall 86 and the second heat dissipation portion 27.

By fixing to the case 80, the heat dissipation member 60 provided between the heat dissipation portions 317, 27 and the heat dissipation wall 86 is pressed in the thickness direction TD, so that the heat-dissipating lower surfaces 317A, 27A and the heat-dissipating upper surface 86A are tightly attached to each other. As a result, the cooling effect is improved. In this third embodiment as described above, similar advantageous effects to those of the first embodiment can be obtained.

### Fourth Embodiment

A fourth embodiment will be described with reference to FIG. 11. FIG. 11 is a cross-sectional view of a capacitor device 5 according to the fourth embodiment. In the following description of the fourth embodiment, changes from the third embodiment will be mainly described. The heat dissipation busbar included in the first busbar 18 may be referred to as a first heat dissipation busbar 416. The capacitor device 5 includes the first heat dissipation busbar 416 and the second heat dissipation busbar 26.

Further, a through hole 42A is formed in the annular wall 42 of the capacitor case 40 so as to penetrate therethrough in the width direction WD. The first heat dissipation busbar 416 is provided at an end of the first power busbar 12 in the width direction WD. The first heat dissipation busbar 416 is integrally connected to the first power busbar 12. The first heat dissipation busbar 416 is continuous with the first power busbar 12 and is made of the same material. The first busbar 18 includes a first power busbar 12, a first capacitor connection terminal 13, and the first heat dissipation busbar 416.

The first heat dissipation busbar 416 is cantilevered from the first power busbar 12. The first heat dissipation busbar 416 is cantilevered from the first capacitor busbar 19. The first heat dissipation busbar 416 extends in the width direction WD so as to be deviated from the capacitor case 40. The first heat dissipation busbar 416 passes through the through hole 42A and extends to the outside of the capacitor case 40.

In the fourth embodiment, one of two heat dissipation walls 86 separated in the width direction WD faces a first heat dissipation portion 417 in the thickness direction TD. The heat dissipation member 60 is provided between the heat dissipation wall 86 and the first heat dissipation portion 417. Similarly, another of the two heat dissipation walls 86 separated in the width direction WD faces the second heat dissipation portion 27 in the thickness direction TD. The heat dissipation member 60 is provided between the heat dissipation wall 86 and the second heat dissipation portion 27.

By fixing to the case 80, the heat dissipation member 60 provided between the heat dissipation portions 417, 27 and the heat dissipation wall 86 is crushed in the thickness direction TD, so that the heat-dissipating lower surfaces 417A, 27A and the heat-dissipating upper surface 86A are closely adhered. As a result, the cooling effect is improved. In this fourth embodiment as described above, similar advantageous to those of the first embodiment can be obtained.

### Fifth Embodiment

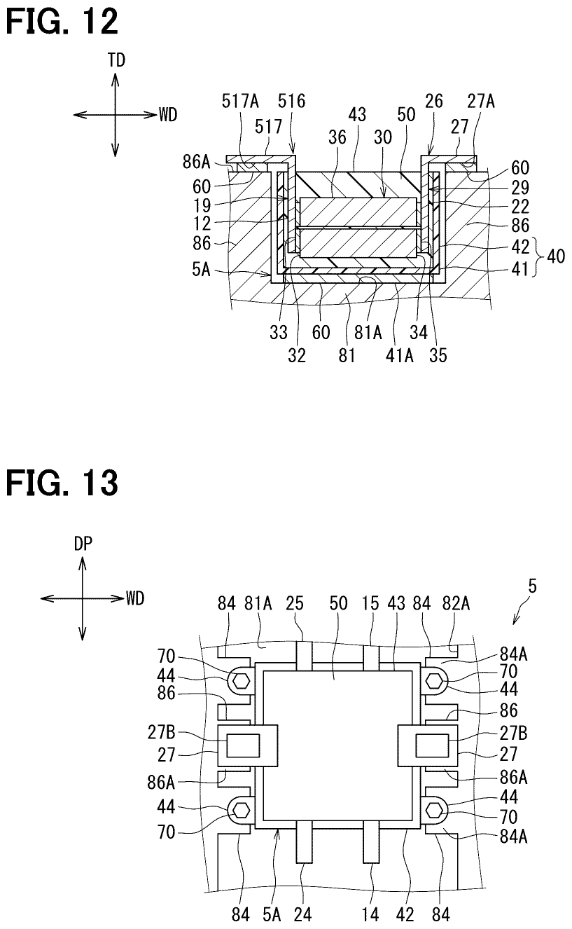

A fifth embodiment will be described with reference to FIG. 12. FIG. 12 is a cross-sectional view of a capacitor device 5 according to the fifth embodiment. In the following description of the fifth embodiment, changes from the third and fourth embodiments will be mainly described. In the fifth embodiment, the capacitor 30 is provided in the capacitor case 40 such that the first electrode 33 and the second electrode 35 are aligned in the width direction WD. The capacitor device 5 includes a first heat dissipation busbar 516 and the second heat dissipation busbar 26. The first power busbar 12 faces the first electrode 33 and extends in the depth direction DP. The second power busbar 22 faces the second electrode 35 and extends in the depth direction DP.

A first heat dissipation busbar 516 is integrally connected to an end portion of the first power busbar 12 in the thickness direction TD. The first heat dissipation busbar 516 is continuous with the first power busbar 12 and is made of the same material. The first busbar 18 includes the first power busbar 12, the first capacitor connection terminal 13, and the first heat dissipation busbar 516. The first heat dissipation busbar 516 is cantilevered from the first power busbar 12. The first heat dissipation busbar 516 is cantilevered from the first capacitor busbar 19.

The first heat dissipation busbar 516 extends in the thickness direction TD beyond the opening 43, and then extends in the width direction WD so as to be deviated from the capacitor case 40. Similarly, the second heat dissipation busbar 26 is integrally connected to an end of the second power busbar 22 in the thickness direction TD. The second heat dissipation busbar 26 extends in the thickness direction TD beyond the opening 43, and then extends in the width direction WD so as to be deviated from the capacitor case 40. The first heat dissipation busbar 516 and the second heat dissipation busbar 26 extend in the width direction WD so as to be deviated from each other.

One of the two heat dissipation walls 86 separated in the width direction WD faces the first heat dissipation portion 517 at the tip of the first heat dissipation busbar 516 exposed from the capacitor case 40 in the thickness direction TD. The heat dissipation member 60 is provided between the first heat dissipation portion 517 and the heat dissipation wall 86 corresponding to the first heat dissipation portion 517. Another of the two heat dissipation walls 86 separated in the width direction WD faces the second heat dissipation portion 27 at the tip of the second heat dissipation busbar 26 exposed from the capacitor case 40 in the thickness direction TD. The heat dissipation member 60 is provided between the second heat dissipation portion 27 and the heat dissipation wall 86 corresponding to the second heat dissipation portion 27.

According to this, by fixing to the case 80, the heat dissipation member 60 provided between the heat dissipation portions 517, 27 and the heat dissipation wall 86 is crushed in the thickness direction TD, so that the heat-dissipating lower surfaces 517A, 27A and the heat-dissipating upper surface 86A are closely adhered. As a result, the cooling effect is improved. In this fifth embodiment as described above, similar advantages to those of the first embodiment can be obtained.

### Sixth Embodiment

A sixth embodiment will be described with reference to FIG. 13. FIG. 13 is a plan view of a capacitor device 5 according to the sixth embodiment. A through hole 27B is formed in the heat dissipation portion 27 so as to penetrate therethrough in the thickness direction TD. In the heat dissipation busbar 26 according to the sixth embodiment, the heat dissipation busbar 26 is also provided on the second capacitor busbar 29 without interrupting the second capacitor busbar 29 in the extension direction of the second capacitor busbar 29. As long as the heat dissipation busbar 26 does not interrupt the second capacitor busbar 29 in the direction in which the second capacitor busbar 29 extends, the shape of the heat dissipation busbar 26 is not limited.

### Seventh Embodiment

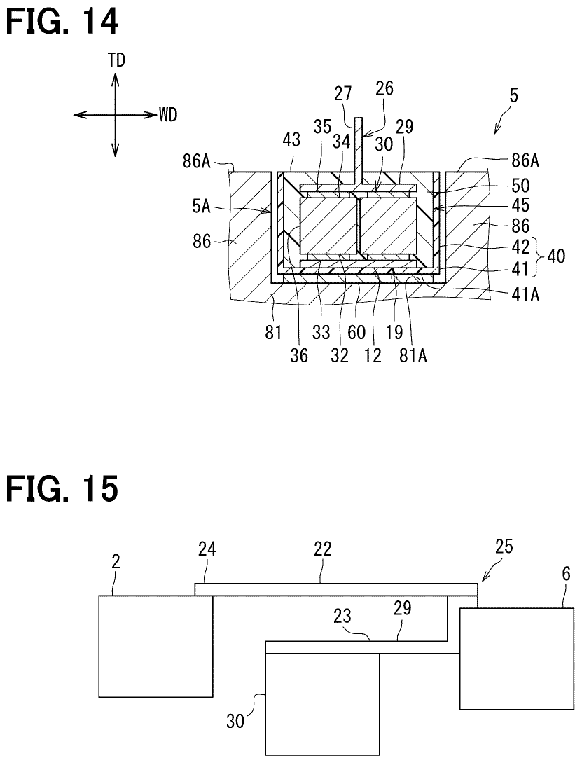

A seventh embodiment will be described with reference to FIG. 14. FIG. 14 is a cross-sectional view of a capacitor device 5 according to the seventh embodiment. The heat dissipation busbar 26 may be provided on a main surface of the second capacitor busbar 29. The heat dissipation busbar 26 extends in the thickness direction TD so as to be deviated from the main surface of the second capacitor busbar 29. In addition, multiple heat dissipation busbars 26 may be provided. The multiple heat dissipation busbars 26 may extend in the thickness direction TD away from the main surface of the second capacitor busbar 29. The heat dissipation portion 27 at the tip of the heat dissipation busbar 26 exposed from the sealing member 50 is exposed to air. This also allows the capacitor 30 to be cooled efficiently.

### Eighth Embodiment

An eighth embodiment will be described with reference to FIG. 15. FIG. 15 is a schematic diagram illustrating a connection configuration of a capacitor device 5 according to the eighth embodiment. In the embodiment described so far, the second power busbar 22 and the second capacitor busbar 29 have a portion in common. However, the second power busbar 22 and the second capacitor busbar 29 do not necessarily have to have some parts in common.

In the eighth embodiment, the second power busbar 22 and the second capacitor busbar 29 are separate. The second power busbar 22 and the second capacitor busbar 29 are separate bodies. In the eighth embodiment, the second power busbar 22 and the second capacitor busbar 29 are electrically and mechanically connected to each other at the second inverter connection terminal 25. In the eighth embodiment, the heat dissipation busbar 26 is also cantilevered from the second capacitor busbar 29. The heat dissipation busbar 26 does not interrupt the second capacitor busbar 29 in the direction in which the second capacitor busbar 29 extends. This also provides the similar advantageous effect.

Although not shown in the drawings, the first power busbar 12 and the first capacitor busbar 19 may be separate. The first power busbar 12 and the first capacitor busbar 19 may be separate bodies. In this case, the first power busbar 12 and the first capacitor busbar 19 are electrically and mechanically connected to each other at the first inverter connection terminal 15. A heat dissipation busbar is cantilevered from the first capacitor busbar 19. The heat dissipation busbar does not interrupt the first capacitor busbar 19 in the direction in which the first capacitor busbar 19 extends. This also provides the similar advantageous effect.

### Other Modifications

In the present embodiment, the configuration in which the capacitor component 5A is connected to the input-side connection portion 3 and the inverter 6 has been mainly described, but the connection of the capacitor component 5A is not limited to this case. As an example, the capacitor component 5A may be connected to the high-voltage battery 2 on the input side. The capacitor component 5A may be connected to another electric component other than the inverter 6 on the output side. Alternatively, the capacitor 30 may be provided in the capacitor case 40 such that the second electrode 35 corresponds to the bottom 41 side and the first electrode 33 corresponds to the opening 43 side. A heat dissipation busbar may be provided only on the first capacitor busbar 19. It is possible that the heat dissipation busbar is provided on at least one of the first capacitor busbar 19 and the second capacitor busbar 29.

Although the present disclosure has been described in accordance with the embodiments, it is understood that the present disclosure is not limited to the embodiments or the structures. The present disclosure encompasses various modified examples and modifications within an equivalent scope. In addition, although various combinations and modes are shown in the present disclosure, other combinations and modes including only one element, more elements, or less elements are also within the scope and idea of the present disclosure.

What is claimed is:

1. A capacitor device comprising:
a capacitor;
a capacitor busbar having a first end and a second end, the first end electrically connected to the capacitor, the second end electrically connected to an electrical component, the capacitor busbar extending in an extending direction in which the capacitor and the electrical component are aligned; and
a heat dissipation busbar configured to dissipate heat generated by the capacitor, the heat dissipation busbar having an end portion at the capacitor busbar without the end portion interrupting the capacitor busbar in the extending direction of the capacitor busbar, wherein
the heat dissipation busbar is configured to carry a lower current than the capacitor busbar.

2. The capacitor device according to claim 1, further comprising:
a capacitor case storing the capacitor, the capacitor busbar, and a part of the heat dissipation busbar in a storage space inside the capacitor case; and
a sealing member that is filled in the storage space and seals the capacitor, the capacitor busbar, and the part of the heat dissipation busbar, wherein
the heat dissipation busbar is cantilevered from the capacitor busbar, and
the heat dissipation busbar includes a heat dissipation portion that is exposed from the sealing member to air.

3. The capacitor device according to claim 2, further comprising:
a heat dissipation member having a higher thermal conductivity than air; and
a case storing the capacitor case, the case configured to allow a coolant flowing inside the case, wherein
the case includes a heat dissipation wall at which the heat dissipation portion is located, and
the heat dissipation member is located between the heat dissipation portion and the heat dissipation wall and in close contact with the heat dissipation portion and the heat dissipation wall.

4. The capacitor device according to claim 3, wherein
the capacitor case further includes:
a bottom;
a side wall rising from the bottom; and
a flange portion extending from the side wall,
the case further includes:
a base at which the bottom is located; and
a fixing wall rising from the base in a thickness direction of the base,
the flange portion is fixed to the fixing wall,
the heat dissipation portion overlaps the heat dissipation wall in the thickness direction, and
the flange portion is fixed to the fixing wall in the thickness direction toward the base, such that the heat dissipation member is in close contact with the heat dissipation portion and the heat dissipation wall.

5. The capacitor device according to claim 4, wherein
a group of the flange portion and the fixing wall is one of groups of flange portions and fixing walls,
the fixing walls are associated with the flange portions, respectively, and
the heat dissipation portion and the heat dissipation wall, which is associated with the heat dissipation portion, are located between two of the groups.

6. The capacitor device according to claim 4, further comprising:
a fixing member having a shaft portion that fixes the flange portion to the fixing wall in the thickness direction, wherein
the heat dissipation portion includes:
a heat-dissipating lower surface facing the heat dissipation wall; and
a heat-dissipating upper surface facing the heat-dissipating lower surface,
the heat-dissipating lower surface and the heat-dissipating upper surface extend in a planar direction perpendicular to the thickness direction, and
the flange portion is pressed against the fixing wall in the thickness direction and fixed to the fixing wall by the fixing member.

7. The capacitor device according to claim 6, wherein
the heat dissipation member is further located between the base and the bottom.

8. The capacitor device according to claim 7, wherein
an upper surface of the base and a lower surface of the bottom extend in the planar direction, and
the flange portion is fixed to the fixing wall in the thickness direction toward the base, such that the heat dissipation member is in close contact with the upper surface of the base and the lower surface of the bottom between the base and the bottom.

9. The capacitor device according to claim 8, wherein
the capacitor includes:
a first electrode located at a first end surface facing the bottom; and
a second electrode located at a second end surface separated from the first end surface in the thickness direction,
the capacitor busbar includes:
a first capacitor busbar connected to the first electrode; and
a second capacitor busbar connected to the second electrode,
the heat dissipation busbar extends in a direction different from a direction in which the second capacitor busbar extends, and is cantilevered from the second capacitor busbar,
the first capacitor busbar is thermally connected to the base via the sealing member, the bottom, and the heat dissipation member, and
the second capacitor busbar is thermally connected to the fixing wall via the heat dissipation member.

10. The capacitor device according to claim 9, wherein
the heat dissipation portion has an uneven shape.
